(19) United States
(12) Patent Application Publication
(10) Pub. No.: US 2007/0242207 A1
(43) Pub. Date: Oct. 18, 2007

(54) FLAT DISPLAY PANEL AND CONNECTION STRUCTURE

(75) Inventor: Akira FUJITA, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: NEC LCD TECHNOLOGIES, Kanagawa (JP)

(21) Appl. No.: 11/734,952

(22) Filed: Apr. 13, 2007

(30) Foreign Application Priority Data
Apr. 18, 2006 (JP) 2006-114042

(51) Int. Cl. G02F 1/1345

(52) U.S. Cl. 349/149

(57) ABSTRACT

In a flat display panel having a panel and a flexible board connected and fixed to each other through an anisotropic conductive film, a surface end of a solder resist formed on the flexible board is located to face a surface end of an insulating film layer formed on the panel. Conductive particles contained in the anisotropic conductive film flowing out during a compression bonding process aggregate in a non-connection region due to the thickness of the insulating resin layer. This makes it possible to substantially completely prevent the short-circuit problem due to the aggregation of the conductive particles.

This application claims priority to prior Japanese application JP 2006-114042, the disclosure of which is incorporated herein by reference.

### BACKGROUND OF THE INVENTION

The present invention relates to a flat display panel and, in particular, to a connection structure between a panel and a flexible board.

It is a general practice in manufacture of a flat display panel such as a liquid-crystal display panel to use an anisotropic conductive film for connecting and fixing a panel to a flexible board. This type of technique is described in Japanese Laid-Open Patent Publication No. 2000-165009, for example.

A description will be made of a conventional connection structure using an anisotropic conductive film, with reference to FIG. 1.

As shown in FIG. 1, a panel 11 has a TFT board 12 and a color filter (CF) board 13. The size of the TFT board 12 is greater than that of the CF board 13. A panel-side connecting terminal electrode 14 is formed on the surface of the TFT board 12 opposing the CF board 13 in a region exposed to the outside.

On the other hand, a flexible board 15 has a base film 16, a Cu foil pattern 17, and an insulating resin layer (hereafter, referred to as the solder resist) 18. An exposed portion of the Cu foil pattern 17 forms a flexible board connecting terminal electrode.

The panel 11 and the flexible board 15 are mechanically connected and fixed to each other by thermocompression bonding with the use of an anisotropic conductive film (hereafter, referred to as the ACF) 19 interposed between a panel connecting terminal electrode 14 and a flexible board connecting terminal electrode (the exposed portion of the Cu foil pattern 17) which are arranged to face each other. The panel connecting terminal electrode 14 and the flexible board connecting terminal electrode (the exposed portion of the Cu foil pattern 17) are electrically connected to each other by conductive particles contained in the ACF 19.

The ACF 19 is deformed (runs out) during the thermocompression bonding, and covers the whole area of the exposed portion including a tip end of the Cu foil pattern 17 (the end face on the side of the CF board 13). The ACF 19 also covers a part of the end face of the TFT board 12 to prevent the flexible board connecting terminal electrode (the exposed portion of the Cu foil pattern 17) from coming into direct contact with the TFT board 12 when the flexible board 15 is bent (when the right side is bent downward as view in FIG. 1). This configuration is able to prevent corrosion and breakage of the flexible board connecting terminal electrode.

Another example of a conventional connection structure is shown in FIG. 2. This type of connection structure is described in Japanese Laid-Open Patent Publication No. 2002-358026, for example.

The connection structure of FIG. 2 is substantially similar to the connection structure of FIG. 1, but is different in the fact that the solder resist 18a of the flexible board 15 is formed so as to penetrate more inside of the panel (to the left side as viewed in FIG. 2) than the end face of the TFT board 12. This means that, although the connection structure of FIG. 1 utilizes the ACF 19 to prevent the direct contact of the flexible board connecting terminal electrode (the exposed portion of the Cu foil pattern 17) with the TFT board 12 when the flexible wiring board 15 is bent, the connection structure of FIG. 2 employs the solder resist 18a in place of the ACF 19.

In the connection structure of FIG. 2 as well, the ACF 19a runs over the end face of the TFT board 12 during thormocompression bonding, whereby the exposed portion of the Cu foil pattern 17 can be covered and an end of the solder resist 18a can be connected and fixed to the panel 11.

Still another example of a conventional connection structure is shown in FIG. 3. This connection structure is similar to the one shown in FIG. 2, but an end of the solder resist 18b is formed into a comb shape. This type of connection structure is described in Japanese Laid-Open Patent Publication No. 2004-118164, for example.

### SUMMARY OF THE INVENTION

However, in the conventional connection structures described above and shown in FIGS. 1 and 2, no consideration is given to aggregation of conductive particles which likely occurs during the thermocompression bonding process using the ACF. Specifically, during the thermocompression bonding process using the ACF, conductive particles contained in the ACF migrate along with the deformation (run out) of the ACF, and if there is any place, such as a bottleneck or step, obstructing the migration path of the conductive particles, the conductive particles will aggregate there. In the connection structure shown in FIG. 2, for example, the space between the tip end of the solder resist 18 and the panel connecting terminal electrode 14 is narrower than the other part, as shown in FIG. 4. Aggregation of the conductive particles likely occurs in this narrower part. As a result, a short-circuit problem may occur between the panel connecting terminal electrodes.

Although the conventional connection structure shown in FIG. 3 is intended to prevent short-circuit due to such aggregation of conductive particles, it is not able to preclude the possibility of occurrence of the short-circuit problem.

As described above, none of the conventional connection structures for connecting a panel and a flexible board in a flat panel display is able to completely prevent the short-circuit problem due to aggregation of conductive particles.

It is therefore an object of the present invention to provide a connection structure for connecting a panel and a flexible board in a flat panel display, which is capable of substantially completely preventing the short-circuit problem due to aggregation of conductive particles.

A first aspect of the present invention relates to a flat display panel having a panel and a flexible board which are connected and fixed to each other with the use of an anisotropic conductive film, and this flat display panel is characterized in that an insulating film layer is formed on a surface end of the panel, and the flexible board and the panel are arranged such that a surface end of an insulating resin layer formed on the flexible board faces the insulating film layer.

A second aspect of the present invention relates to a connection structure for connecting and fixing a first wiring board and a second wiring board to each other with the use of an anisotropic conductive film. This connection structure is characterized in that an insulating film layer is formed on a surface end of the first wiring board, and the second wiring board and the first wiring board are arranged such that a surface end of an insulating resin layer formed on the second wiring board faces the insulating film layer.

According to the present invention, the insulating film layer is formed on the surface end of the panel, and the surface end of the insulating resin layer formed on the flexible board is located to face the insulating film layer. According to this configuration, aggregation of conductive particles which occurs when connecting and fixing the panel and the flexible board with the use of the anisotropic conductive film can be caused to occur between the insulating resin layer and the insulating film layer. This makes it possible to prevent the short-circuit problem which may occur between the panel-side connecting terminal electrodes due to the aggregation of the conductive particles.

Further, according to the present invention, the insulating film layer is formed on the surface end of the first wiring board, and the surface end of the insulating resin layer formed on the second wiring board is located to face the insulating film layer. According to this configuration, the aggregation of the conductive particles which occurs when connecting and fixing the first wiring board and the second wiring board with the use of the anisotropic conductive film can be caused to occur between the insulating resin layer and the insulating film layer. This makes it possible to prevent the short-circuit problem which may occur between the connecting terminal electrodes on the first wiring board due to the aggregation of the conductive particles.

### BRIEF DESCRIPTION OF THE DRAWINGS

FIG. 1 is a partial cross sectional view showing a connection portion between a panel and a flexible board in a conventional flat display panel;

FIG. 2 is a partial cross sectional view showing a connection portion between a panel and a flexible board in another conventional flat display panel;

FIG. 3 is a partial plan view showing a connection portion between a panel and a flexible board in still another conventional flat display panel;

FIG. 4 is a partial cross sectional view for explaining a problem inherent in conventional flat display panels;

FIG. 5A is partial plan view showing a connection portion between a panel and a flexible board of a flat panel display according to a first embodiment of the present invention, and FIG. 5B is a cross sectional view thereof;

FIG. 6A shows a state before the connection between the panel and the flexible board of the flat panel display shown in FIGS. 5A and 5B, while FIG. 6B shows a state after the connection;

FIG. 7A is a front view for explaining the shape of the tip end of a solder resist in the flat panel display shown in FIGS. 5A and 5B, while FIG. 7B is a cross sectional view taken along the line B-B′ of FIG. 7A; and

FIG. 8A is a partial plan view showing a connection portion between a panel and a flexible board of a flat panel display according to a second embodiment of the present invention, while FIG. 8B is a cross sectional view thereof.

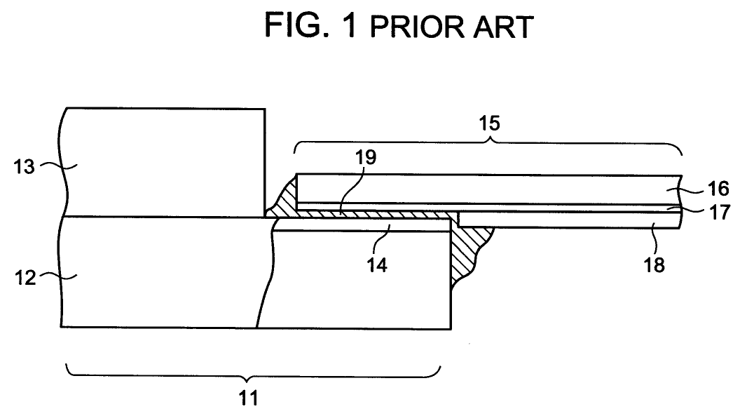

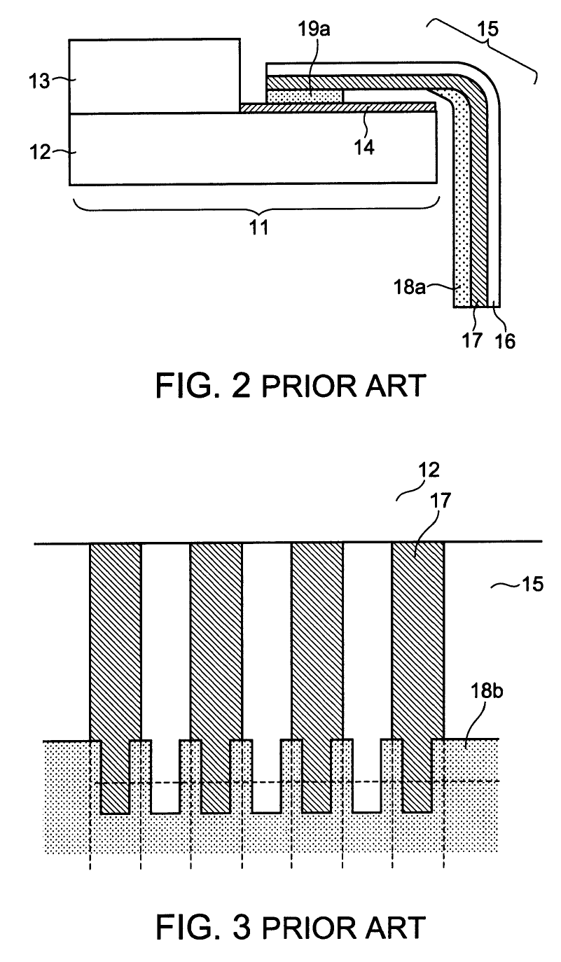

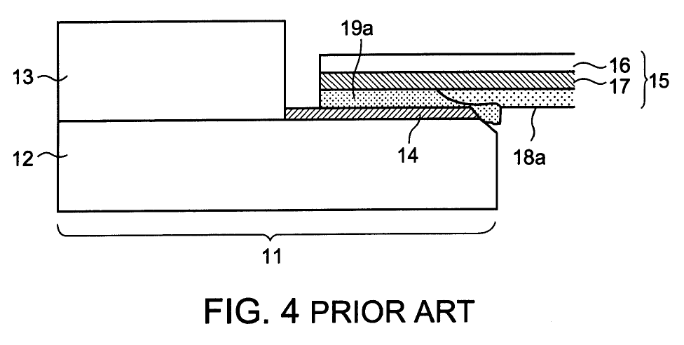

### DESCRIPTION OF THE PREFERRED EMBODIMENTS

Preferred embodiments of the present invention will be described with reference to the accompanying drawings.

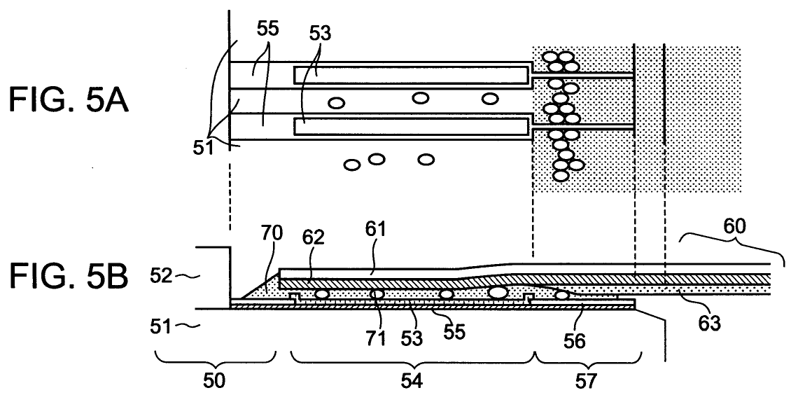

FIGS. 5A and 5B are a partial plan view and a partial cross sectional view, respectively, of a flat panel display (liquid-crystal display device) according to a first embodiment of the present invention.

The liquid-crystal display device shown in these figures have an LCD panel 50 and a flexible board 60.

The LCD panel 50 has two glass boards, or a TFT board 51 and a color filter (CF) board 52. Pixel electrodes, scanning lines and signal lines (not shown) are formed on one surface of the TFT board 51. Color layers (not shown) assigned to the pixels are formed on one surface of the CF board 52.

The TFT board 51 and the CF board 52 are bonded together with a liquid-crystal layer interposed therebetween, and are sandwiched by a pair of polarizing plates (not shown).

The TFT board 51 has a greater size than the CF board 52, and the end face of the TFT board 51 projects out further than the end face of the CF board 52. A panel terminal electrode (for example, a transparent conductive film layer) 53, which is connected to any one of the scanning lines and signal lines, is formed on the surface of this projected portion of the TFT board 51 (the surface on the side of the CF board 52, or the topside surface as viewed in FIG. 5B). A non-connection region 57 having a base-metal wiring layer 55 the surface of which is covered with an insulating film layer 56 is formed on a region closer to the end face side (the right side as viewed in FIG. 5B) than a region (valid connection region) 54 where the panel terminal electrode 53 is formed.

In order to form the panel terminal electrode 53, firstly the base-metal wiring layer 55 is formed on the surface of the TFT board 51. The insulating film layer 56 is then formed to cover the base-metal wiring layer 55. Subsequently, a contact hole is formed in the insulating film layer 56. A transparent conductive film layer which electrically conducts with the base-metal wiring layer 55 through the contact hole is formed to provide the panel terminal electrode 53. This transparent conductive film layer is provided in a position corresponding to the connecting terminal electrode of the flexible board 60. The formation of the transparent conductive film layer is performed simultaneously with the formation of the pixel electrodes described above.

On the other hand, the flexible board 60 has a base film 61 formed of an insulating resin such as polyimide. The base film 61 has a thickness of 10 to 40 μm, for example, and has sufficient flexibility. A wiring pattern 62 (for example a Cu foil pattern) is formed on the surface of the base film 61, and a semiconductor element (not shown) functioning as a liquid-crystal driving element is mounted on the wiring pattern 62. The flexible board 60 having a semiconductor element (LSI) mounted thereon is generally referred to as a COF (Chip On Film).

The flexible board 60 also has a solder resist 63 formed to cover the surface of the wiring pattern 62 except a part thereof, and serving as an insulating protective layer. The solder resist 63 is formed of an insulating material (resin) such as polyimide or urethane, and is formed on the wiring pattern 62 by a resin application method or thermocomprssion bonding method. The solder resist 63, which works for insulation protection and corrosion protection of the wiring pattern 62, has a thickness large enough to fulfill the function as a protective film, for example of 5 μm or more. The thickness of the solder resist 63 is, however, preferably 40 μm or less so as not to impair the flexibility of the flexible board 60.

The exposed portion (the portion not covered with the solder resist 63) of the wiring pattern 62 functions as a flexible board terminal electrode which is electrically connected to the panel terminal electrode 53.

The LCD panel 50 and the flexible board 60 are mutually connected and fixed with the use of an anisotropic conductive film (ACF) 70. In general, the ACF 70 is formed into a thin film shape by dispersing conductive particles 71 in an insulating adhesive material. The insulating adhesive material plays a function to mechanically fix the LCD panel 50 and the flexible board 60 to each other, while the conductive particles 71 play a function of electrical connection between the panel terminal electrode 53 and the flexible board terminal electrode.

The insulating adhesive material usable for the ACF 70 is preferably composed of a thermosetting epoxy resin or acrylic resin. The conductive particles 71 may be metallic fine particles of Ni or the like, or resin particles plated with Ni/Au. Plated spherical resin particles having a particle size of 3 to 10 μm are most preferable as the conductive particles 71.

The ACF 70 formed of the materials as described above is arranged between the LCD panel 50 and the flexible board 60, and heated at a temperature of about 150 to 200° C. for 5 to 20 seconds while being applied with a load of about 1 to 5 MPa. The ACF 70 is thus cured, and the LCD panel 50 and the flexible board 60 are thereby mechanically fixed to each other and, at the same time, the panel terminal electrode 53 and the flexible board terminal electrode are electrically connected to each other.

The opposite end of the flexible board 60 from the end connected to the LCD panel 50 is connected to a printed circuit board or the like (not shown) to be supplied with power from a power supply circuit or the like. This enables the semiconductor element mounted on the flexible board 60 to operate as a liquid-crystal driving circuit for driving liquid crystals of the LCD panel 50.

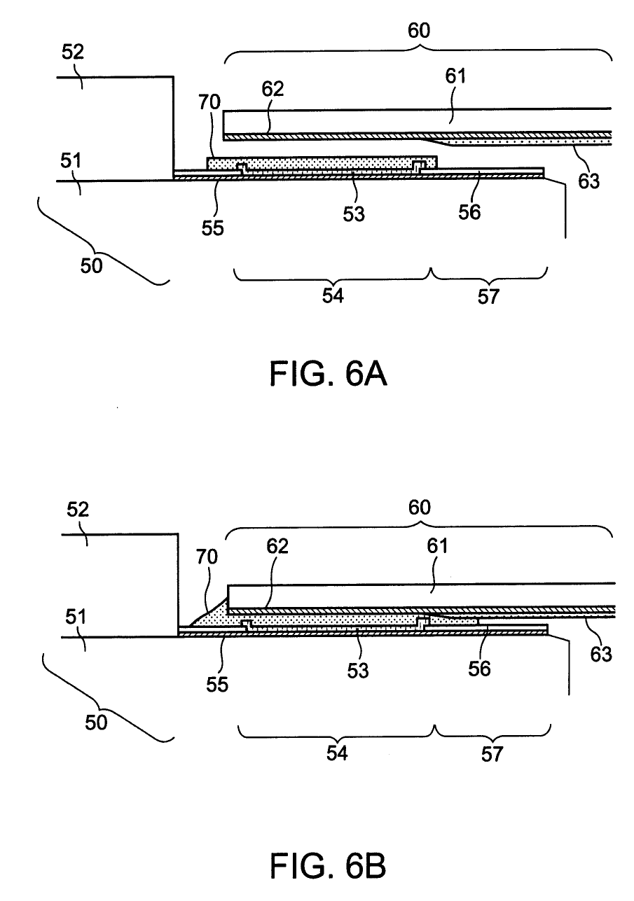

Referring to FIGS. 6A and 6B, a description will be made of a process for connecting the LCD panel 50 and the flexible board 60.

As shown in FIG. 6A, the ACF 70 is placed in a position covering the panel terminal electrode 53. The flexible board 60 is aligned such that the tip end of the solder resist 63 (the end closer to the CF board, or on the left side as viewed in FIG. 6A) is located above the non-connection region 57, and more desirably located above the vicinity of the boundary between the valid connection region 54 and the non-connection region 57. In other words, the tip end of the solder resist 63 is arranged more inside than the end of the base-metal wiring layer 55 (closer to the center of the LCD panel) such that the surface end of the solder resist 63 faces the insulating film layer 56 in the non-connection region 57 (that is, the surface end of the insulating film layer 56).

The LCD panel 50 and the flexible board 60 in the state as shown in FIG. 6A are held from the top and bottom as viewed in the drawing by means of a crimp tool not shown, and heated and pressed at a predetermined temperature under a predetermined pressure for a predetermined time. The ACF 70 is thus softened and flows out to the periphery as shown in FIG. 6B. The ACF 70 having flown out toward the CF board 52 (to the left side as viewed in the drawing) covers the wiring pattern 62 exposed from the CF board-side end face of the flexible board 60. The ACF 70 having flown out toward the flexible board 60 (toward the end face of the TFT boars, or the right side as viewed in the drawing) covers the wiring pattern 62 exposed in the connection region and further flows into the non-connection region 57. As a result, the wiring pattern 62 of the flexible board 60 is completely covered with the ACF 70, and no exposed portion is left. The conductive particles 71 contained in the ACF 70 flowing into the non-connection region 57 aggregate in a part where the flow path is narrowed by the thickness of the solder resist 63.

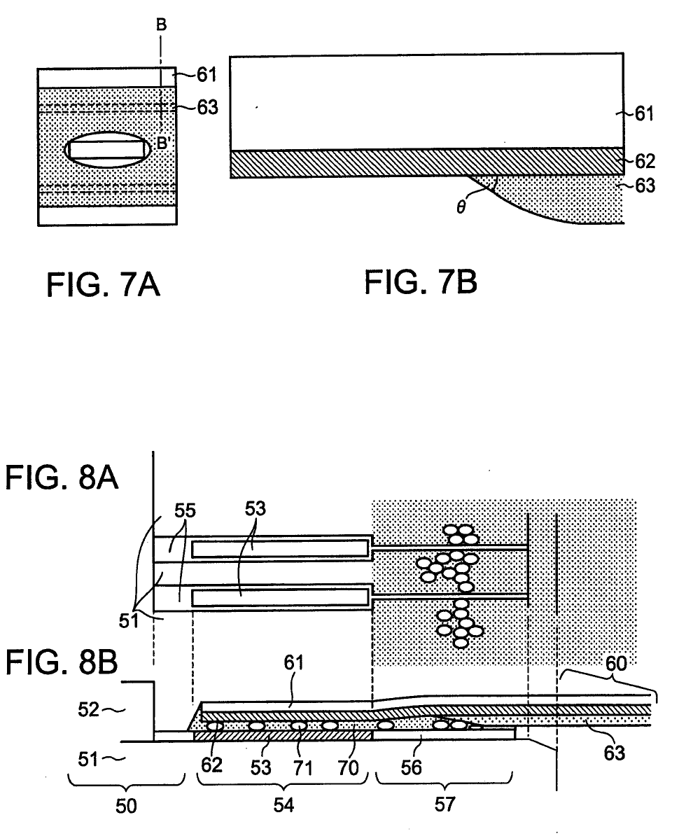

As shown in FIGS. 7A and 7B, the shape of the end (the tip end shape) of the solder resist 63 is a forward tapered shape (a shape having a point angle θ of 90 degrees or less), desirably a gently forward-tapered shape (θ≦10 degrees, for example). According to this configuration, the conductive particles 71 of the ACF 70 having a predetermined particle size flows out to reach a position away from the boundary between the valid connection region 54 and the non-connection region 57, specifically to a part in the tapered portion where the gap defined between the surface of the insulating film layer 56 and the opposing surface of the solder resist 63 becomes narrower than the particle size of the conductive particles 71, and the conductive particles 71 are blocked by the tapered portion of the solder resist.

According to this embodiment as described above, the aggregation of the conductive particles 71 of the ACF 70 occurs in the non-connection region 57. This means that the aggregation of the conductive particles 71 of the ACF 70 occurs between the solder resist 63 and the insulating film layer 56. Since neither the wiring pattern 62 nor the base-metal wiring layer 55 is exposed in this region, no short-circuit problem will be induced by the aggregation of the conductive particles 71.

In the flat panel display according to this embodiment as described above, the wiring pattern 62 is not exposed outside. Therefore, it is possible to prevent the entry of foreign metallic particles or water from the outside, and hence it is possible to prevent the short-circuit problem.

Further, the place where the aggregation of the conductive particles 71 of the ACF 70 occurs can be led into non-connection region 57 by appropriately selecting the thickness and the tip end angle of the solder resist 63, the particle size of the conductive particles 71 of the ACF 70, the material for the adhesive material, the temperature and pressure during the compression bonding, and the width of the non-connection region 57. This provides a connection structure capable of substantially eliminating the problem of electric short-circuit.

Since the tip end of the solder resist 63 is located more inside than the end of the LCD panel, the wiring pattern 62 will not be brought into direct contact with the TFT board 51 even when the flexible board 60 is bent. Therefore, the disconnection due to such direct contact can be prevented.

Further, since the CF board-side end of the wiring pattern 62 is also covered with the ACF 70, there is no necessity to separately provide a protective layer.

A second embodiment of the present invention will be described with reference to FIGS. 8A and 8B. In FIG. 8B, a base metal layer 55 is omitted.

In the second embodiment, a TCP (Tape Carrier Package) in place of the COF is used as a flexible board 60. The TCP has a base film 61 with a thickness of about 75 μm and hence has less flexibility in comparison with the COF. Therefore, the connection portion formed by the ACF 70 is stressed in the peeling direction due to the effect of the thickness of the solder resist 63, resulting in poor reliability. In other words, the connection between the panel terminal electrode 53 and the flexible board terminal electrode is adversely affected when the tip end of the solder resist 63 is located in the vicinity of the boundary between the valid connection region 54 and the non-connection region 57.

Therefore, according to the second embodiment, as shown in FIG. 8B, the tip end of the solder resist 63 is located closer to the panel end face relative to the boundary between the valid connection region 54 and the non-connection region 57. The crosswise distance between the boundary and the tip end of the solder resist 63 as viewed in FIG. 8B is for example 0.1 mm or more, and desirably 0.3 mm or more.

When the connection is made with the use of the ACF 70 with the LCD panel 50 and the flexible board 60 being arranged as described above, the stress applied to the ACF connection surface can be alleviated, and the desired effects can be obtained.

Having described the present invention as related to the two embodiments, it should be understood that the present invention is not limited to these embodiments. For example, although the embodiments have been described using a liquid-crystal display device as an example of a flat panel display, the present invention is also effective applicable to other flat panel displays, such as a plasma display panel, an organic EL display, or a surface-conduction electron-emitter display (SED).

Further, the connection structure of the present invention is not limited to use in a flat panel display, but also applicable to any portion where two wiring boards are connected by means of an ACF.

The materials usable for the elements and components are not restricted to those described above. For example, the material of the wiring pattern is not limited to Cu, but may be other conductive materials such as Ag. Further, the adhesive material for the ACF is not limited to a thermosetting material but may be an ultraviolet-setting resin.

In the embodiments above, the tip end shape of the solder resist is a forward tapered shape. However, the tip end shape may be a square shape (i.e., the tip end angle is 90 degrees). In this case, the same effects can be obtained, by aligning the tip end of the solder resist at a position slightly away from the boundary between the valid connection region and the non-connection region toward the end face of the panel in a similar manner to the second embodiment.

What is claimed is:

1. A flat display panel having a panel and a flexible board which are connected and fixed to each other with the use of an anisotropic conductive film, wherein:
an insulating film layer is formed on a surface end of the panel; and
the flexible board and the panel are arranged such that a surface end of an insulating resin layer formed on the flexible board faces the insulating film layer.

2. The flat display panel according to claim 1, wherein aggregation of conductive particles contained in the anisotropic conductive film occurs in a region where the insulating film layer and the insulating resin layer face each other.

3. The flat display panel according to claim 1, wherein the tip end of the forward tapered shape of the insulating resin layer has a cross-sectional angle of 90 degrees or less at thereof.

4. The flat display panel according to claim 2, wherein the tip end of the forward tapered shape of the insulating resin layer has a cross-sectional angle of 90 degrees or less at thereof.

5. The flat display panel according to claim 1, wherein the end face of a connecting terminal electrode formed on the flexible board is covered with the anisotropic conductive film.

6. A connection structure for connecting and fixing a first wiring board and a second wiring board to each other with the use of an anisotropic conductive film, wherein:
an insulating film layer is formed on a surface end of the first wiring board; and
the second wiring board and the first wiring board are arranged such that a surface end of an insulating resin layer formed on the second wiring board faces the insulating film layer.

7. The connection structure according to claim 6, wherein aggregation of conductive particles contained in the anisotropic conductive film occurs in a region where the insulating film layer and the insulating resin layer face each other.

8. The connection structure according to claim 6, wherein the tip end of the forward tapered shape of the insulating resin layer has a cross-sectional angle of 90 degrees or less.

9. The connection structure according to claim 7, wherein the tip end of the forward tapered shape of the insulating resin layer has a cross-sectional angle of 90 degrees or less.

10. The connection structure according to claim 6, wherein the end face of a connecting terminal electrode formed on the flexible board is covered with the anisotropic conductive film.
